(19) United States
(12) Patent Application Publication
(10) Pub. No.: US 2007/0112481 A1
(43) Pub. Date: May 17, 2007

(54) WIRELESS RAIL DETECTION SYSTEM

(76) Inventors: Dong-Huang Tsai, Hsinchu City (TW); Lai-Cheng Chen, Taichung County (TW); Rong-Chung Jin, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,141

(22) Filed: Nov. 11, 2005

(51) Int. Cl. G06F 17/00

(52) U.S. Cl. 701/19; 701/2

(57) ABSTRACT

A wireless rail detection system is disclosed. A wireless detecting device is disposed on a trolley. When the trolley moves along the rail, the system acquires image and temperature data of the rail through a camera or a temperature measuring device of the wireless detecting device. The data is then transferred to a remote monitoring device through a wireless transmission interface for the factory staff's inspection. Therefore, the danger and the manpower of the manual detection method can be reduced. The purpose of monitoring the state of the rail can also be achieved.

### BACKGROUND OF THE INVENTION

1. Field of Invention

The present invention relates to a detection system. More particularly, the present invention relates to a wireless rail detection system wherein a wireless detecting device is disposed on a trolley so as to detect the state of the rail.

2. Description of Related Art

Along with the rapid development of the semiconductor industry, the semiconductor manufacturers have been actively expanding the factories to meet the extensive market demands. However, with the expanding factory area, the transportation requirements of materials and products in the factories are increasing accordingly. Therefore, nowadays, in semiconductor manufactories, the automatic transportation systems are widely used to connect machines in the factory to speedily transport the needed materials.

Based on the above, the highly efficient vehicle distribution system with multiple transportation functions is gradually adopted by the manufacturers. Wherein, the overhead hoisting system, OHS, is among the most commonly used. The factory staff can use the computer of the vehicle distribution system to integrate the resources of vehicles and machines in the factory and program the routes for transporting the materials and products so as to reach the maximum productive capacity and lower the cost.

In the system, in order to provide the electric power for trolleys to move and transport the materials, the power line is disposed inside the rail. The power line is subject to gradual wear and tear due to the vibrating of the trolleys during the transportation, which results in some potential safety hazards due to the exposed copper wires inside the power line or the overheated power line. Accordingly, the factory staffs have to inspect the power line circuitry periodically to prevent the above situations.

However, as the rail of the system spreads all over the factory and the route is long and complicated, which can be 3 to 5 kilometers of the total length of the rail in big factories, manual inspection would take 1 to 2 weeks, and as the power line is of high voltage, the danger to the factory staff during inspection will also increase.

To sum up, the traditional inspection method has at least the following disadvantages.

1. Manual rail inspection is a waste of human resources.

2. It is unable to monitor whether the high voltage power line is overheated or damaged, therefore it is a safety hazard.

3. The staffs are exposed to the danger of touching the high voltage.

### SUMMARY OF THE INVENTION

Accordingly, the present invention is directed to provide a wireless rail detection system, wherein a wireless detecting device is disposed on a trolley to transmit the image of the rail in real-time so as to monitor the state of the rail.

The present invention provides a wireless rail detection system for detecting the state of the rail in an automatic transportation system. The wireless rail detection system includes a detecting device and a monitoring device. Wherein, the detecting device, disposed on a trolley moving along the rail, captures and outputs the image of the rail when the trolley moves along the rail. The monitoring device receives and displays the image.

According to the wireless rail detection system of a preferred embodiment of the present invention, the aforementioned detecting device includes an image capturing unit and a wireless transmission interface. Wherein, the image capturing unit captures the image of the rail when the trolley moves along the rail. The wireless transmission interface is coupled with the image capturing unit and outputs the image.

According to the wireless rail detection system of the preferred embodiment of the present invention, the aforementioned image capturing unit includes a charge-coupled device camera (CCD camera).

According to the wireless rail detection system of the preferred embodiment of the present invention, the aforementioned wireless transmission interface includes one of According to the wireless rail detection system of the preferred embodiment of the present invention, the aforementioned detecting device further includes a temperature detecting unit to detect the temperature of the power line in the rail when the trolley moves along the rail. Wherein, the temperature data is transmitted to the monitoring device through the wireless transmission interface and displayed on the monitoring device.

According to the wireless rail detection system of the preferred embodiment of the present invention, wherein, when the temperature is higher than a predetermined value, a warning is sent by the monitoring device.

According to the wireless rail detection system of the preferred embodiment of the present invention, the aforementioned temperature detecting unit includes a laser temperature gauge.

According to the wireless rail detection system of the preferred embodiment of the present invention, the aforementioned monitoring device includes a wireless receiving unit and a screen. Wherein, the wireless receiving unit receives the image output by the detecting device; the screen is coupled with the wireless receiving unit and displays the image received by the wireless receiving unit.

According to the wireless rail detection system of the preferred embodiment of the present invention, the aforementioned automatic transportation system includes an overhead hoisting system (OHS).

The present invention adopts the structure in which a wireless detecting device is disposed on a trolley so that when the trolley moves along the rail, the image and temperature information of the rail can be obtained and the purpose of monitoring the state of the rail can also be achieved

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a block diagram of a wireless rail detection system according to the preferred embodiment of the present invention.

FIG. 2 is an arrangement diagram of the detecting device according to the preferred embodiment of the present invention.

### DESCRIPTION OF EMBODIMENTS

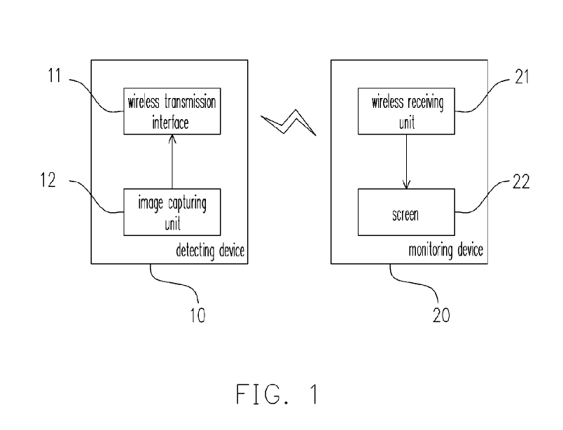

FIG. 1 is a block diagram of a wireless rail detection system according to the preferred embodiment of the present invention. Referring to FIG. 1, the present embodiment is adapted for detecting the state of the rail of the automatic transportation system, such as the state of the power line. The system includes a detecting device 10 and a monitoring device 20. The detecting device 10 includes a wireless transmission interface 11 and an image capturing unit 12. The monitoring device 20 includes a wireless receiving unit 21 and a screen 22. Wherein, the automatic transportation system can be an overhead hoisting system or other kind of transportation systems.

The detecting device 10 is disposed on the trolley of the aforementioned automatic transportation system. When the trolley moves, the image capturing unit 12 in the trolley starts to capture the image of the rail and output the image data through the wireless transmission interface 11. Wherein, the image capturing unit 12 can be a charge-coupled device camera; the wireless transmission interface can be a bluetooth interface or a radio frequency interface. Without departing from the scope or spirit of the present invention, users can use other kind of image capturing unit and wireless transmission interface according to the actual requirement.

Next, the monitoring device 20 disposed at a remote end receives the image data output by the wireless transmission interface 11 with the built-in wireless receiving unit 21 and displays the image data on the screen 22. By the above method, the factory staff can monitor the state of the rail at any moment and be aware of the damage of the power line or other lines caused by the friction of the trolley in real-time, such that the potential dangers from the damage can be avoided.

Besides, in an embodiment of the present invention, the detecting device 10 can further includes a temperature detecting unit used to detect the temperature of the power line in the rail when the trolley moves along the rail and then transmit the temperature data to the monitoring device 20 through the same wireless transmission interface. The temperature data is then displayed on the screen 22 for the factory staff to monitor. Furthermore, the factory staff can set a predetermined value in the monitoring unit 20 in advance. When the temperature of the detected power line is higher than the predetermined value, the monitoring device sends a warning sound or pops a warning message on the screen 22 to alert the factory staff of the abnormal state so as to avoid the potential dangers. Wherein, the temperature detecting unit can be a laser temperature gauge.

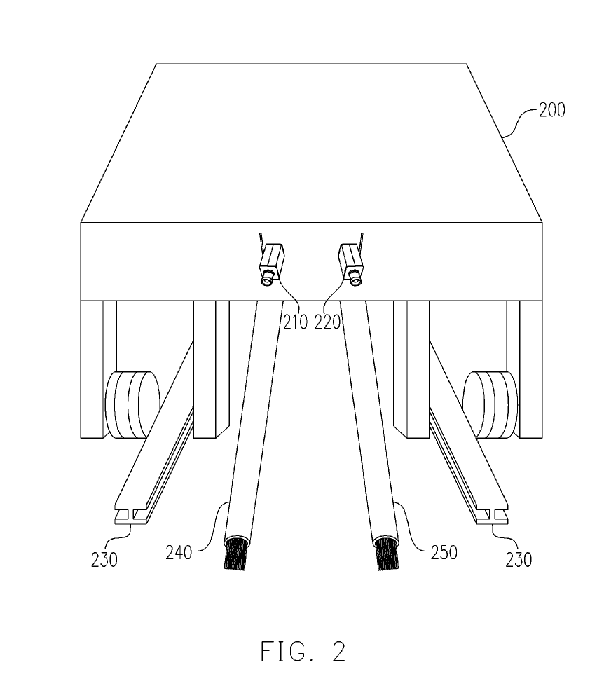

FIG. 2 is an arrangement diagram of the detecting device according to the preferred embodiment of the present invention. Referring to FIG. 2, the present embodiment includes 2 detecting devices, 210 and 220, which are disposed respectively on different places of the trolley 200. The image capturing units in the detecting devices are respectively aligned with the power lines 240 and 250 in the rail 230. When the trolley 200 moves, the detecting devices 210 and 220 can capture the images of the power lines 240 and 250 at any moment and transmit the image signals to the remote monitoring device through the built-in wireless transmission interface for the factory staff to detect the state of the power lines in real-time.

In addition, the detecting devices 210 and 220 can further includes a temperature detecting unit to measure the temperatures of the power lines 240 and 250 so as to detect the changes of the temperatures of the power lines to avoid the danger caused by the excessive current or the overheating of the power lines.

By the above method, only one trolley of the automatic transportation system needs to be installed with the detecting devices for detecting the state of the power lines of the whole rail system. Compared with 1 to 2 weeks required in the traditional manual inspection method, the present invention only needs 1 to 2 hours to finish the inspection, so that, the present invention can greatly save human resources and effectively prevent the potential dangers.

In summary, because the wireless rail detection system of the present invention dispose a wireless detecting device on a trolley, when the trolley moves along the rail, the system can acquire image and temperature data of the rail through a camera and a temperature measuring gauge on the detecting device, and then transfer the data to a remote monitoring device to display through a wireless transmission interface, so that the danger and manpower in the manual inspection method can be reduced and the purpose of monitoring the state of the rail in real-time can also be achieved. Of course, in addition to the power line detection illustrated in the embodiment of the patent specification, the present invention can be applied to all other state detections of rail in the whole automatic transportation system.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordant with the scope of the following claims and their equivalents.

What is claimed is:

1. A wireless rail detection system, for detecting the state of a rail of an automatic transportation system; the system comprising:
a detecting device, disposed on a trolley moving along the rail, for acquiring an image and a temperature of the rail when the trolley moves along the rail and output the image; and
a monitoring device, for receiving and displaying the image and the temperature.

2. The wireless rail detection system as claimed in claim 1, wherein, the detecting device comprises:
an image capturing unit for capturing the image of the rail when the trolley moves along the rail; and
a wireless transmission interface, coupled with the image capturing unit, for outputting the image.

3. The wireless rail detection system as claimed in claim 2, wherein, the image capturing unit comprises a charge-coupled device camera.

4. The wireless rail detection system as claimed in claim 2, wherein, the wireless transmission interface comprises one of a bluetooth interface and a radio frequency interface.

5. The wireless rail detection system as claimed in claim 1, wherein, the detecting device further comprises:
a temperature detecting unit for measuring a temperature of the power line of the rail when the trolley moves along the rail, wherein the temperature data is transmitted to the monitoring device through the wireless transmission interface and displayed on the monitoring device.

6. The wireless rail detection system as claimed in claim 5, wherein, when the temperature is higher than a predetermined value, the monitoring device sends a warning message.

7. The wireless rail detection system as claimed in claim 5, wherein, the temperature detecting unit comprises a laser temperature gauge.

8. The wireless rail detection system as claimed in claim 1, wherein, the monitoring device comprises:
a wireless receiving unit, for receiving the image output by the detecting device; and
a screen, coupled with the wireless receiving unit, for displaying the image received by the wireless receiving unit.

9. The wireless rail detection system as claimed in claim 1, wherein, the automatic transportation system comprises an overhead hoisting system.
